(19) United States
(12) Patent Application Publication
(10) Pub. No.: US 2025/0184196 A1
(43) Pub. Date: Jun. 5, 2025

(54) SUBCARRIER SPACING CONFIGURATION IN SIDELINK COMMUNICATIONS

(71) Applicant: ZTE CORPORATION, Shenzhen, Guangdong (CN)

(72) Inventors: Yuzhou HU, Shenzhen, Guangdong (CN); Youxiong LU, Shenzhen, Guangdong (CN); Weimin XING, Shenzhen, Guangdong (CN); Haigang HE, Shenzhen, Guangdong (CN); Feng BI, Shenzhen, Guangdong (CN); Jie CHEN, Shenzhen, Guangdong (CN); Ting MIAO, Shenzhen, Guangdong (CN)

(21) Appl. No.: 18/844,693

(22) PCT Filed: Apr. 29, 2022
(86) PCT No.: PCT/CN2022/090112

§ 371 Date: Sep. 6, 2024

(51) Int. Cl. H04L 27/26; H04W 72/25

(52) U.S. Cl. CPC H04L 27/26025; H04W 72/25

(57) ABSTRACT

Subcarrier spacing (SCS) configuration in sidelink communications between devices may be needed with multiple carriers. Either the SCS of different carriers are configured the same or the same reference SCS is utilized to prevent certain communication problems. The reference SCS determined for multiple carriers in a sidelink communication may be determined from a set including different SCS values. The reference SCS can be utilized for each of the multiple carriers in the sidelink communication for subsequent communications.

### TECHNICAL FIELD

This document is directed generally to wireless communications. More specifically, the wireless communications include sidelink communications with subcarrier spacing configurations.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. With the development of wireless multimedia services, demands of high data rate services are increasing as well as the requirements for system capacity and coverage of conventional cellular network. In addition, increased usage for public safety, social network, short distance data sharing, local advertisement, and other demands of proximity services which allow people to communicate with adjacent people or objects are also increasing. Device-to-device (D2D) communication/sidelink technology may serve such demands. In order to improve communications and meet reliability requirements for the vertical industry as well as support the new generation network service, communication improvements for D2D/sidelink should be made.

### SUMMARY

This document relates to methods, systems, and devices for subcarrier spacing (SCS) configuration in sidelink communications between devices. There may be multiple carriers and either ensuring the SCS of different carriers are configured the same or utilizing the same reference SCS can prevent certain communication problems. The reference SCS determined for multiple carriers in a sidelink communication may be determined from a set including different SCS values. The reference SCS can be utilized for each of the multiple carriers in the sidelink communication for subsequent communications.

In one embodiment, a method for wireless communication includes determining a reference subcarrier spacing (SCS) for multiple carriers in a sidelink communication; and utilizing the reference SCS for each of the multiple carriers in the sidelink communication. Each SCS for the multiple carriers are configured the same as the reference SCS. Frequencies for the multiple carriers are configured using the reference SCS. The frequencies are for the configuration information of candidate carrier for transmission (Tx) carrier selection/re-selection or synchronization carrier configuration information. The carrier for transmission (Tx) carrier selection/re-selection configuration information comprises a list of frequencies in sl-FreqInfoList and the synchronization carrier configuration information comprises a list of frequencies in syncFrequencyList. The configuration using the reference SCS ensures transmission boundary alignment. The determining of the reference SCS is based on an implicit criteria comprising at least one of a traffic information including priority level, a remaining packet delay budget (PDB), a carrier corresponding to a logical channel, a transmission congestion level including a Channel Busy Ratio (CBR) or Channel Occupancy Radio (CR), a largest SCS value, a smallest SCS value, a frequency configured most frequently, a frequency configured least frequently, a frequency list associated with traffic, a SCS of a synchronization frequency reference subcarrier spacing,or a SCS of a candidate carrier for transmission (Tx) carrier selection/re-selection. The determining of the reference SCS with the CBR or the CR is based on a frequency with the CBR or the CR measurement is either a lowest or a highest. The determining of the reference SCS with the logical channel is based on a frequency whose corresponding logical channel measures the CBR or the CR values either below or above a threshold. The determining of the reference SCS with the frequency carrying traffic is based on the frequency carrying traffic with a highest or a lowest priority value. The determining of the reference SCS with the PDB is based on the frequency carrying traffic with a smallest or a largest remaining packet delay budget (PDB). The determining of the reference SCS is based on an explicit criteria comprising using a configured/preconfigured SCS and the configured/preconfigured SCS can be for example an information element (IE) of sl-FreqInfoList or inIE syncFrequencyList. Only the carrier(s) whose SCS the same as the configured/preconfigured SCS can be used for candidate carrier for transmission (Tx) carrier selection/re-selection and/or synchronization frequency reference subcarrier spacing. The determining and utilizing is by a user equipment (UE). The UE performs the sidelink communication with the multiple carriers. The determining and utilizing is by a base station in communication with the UE.

In some embodiments, the method includes applying the reference SCS to subsequent communications. In some embodiments, the method includes selecting a frequency for a synchronization reference based on the reference SCS. In some embodiments, the method includes selecting a frequency for Tx carrier(s) based on the reference SCS. A transmission priority is based on the reference SCS. The reference SCS is utilized for a transmission phase for a simultaneous transmission/reception, wherein simultaneous transmission/reception channels or signals with the reference SCS are utilized for a priority comparison. The channels or signals comprises channels or signals from new radio (NR), long term evolution (LTE), physical sidelink feedback channel (PSFCH), sidelink, or uplink.

In one embodiment, a method for wireless communication includes identifying a subcarrier spacing (SCS) for multiple carriers in a sidelink communication; determining a reference SCS for the multiple carriers; and utilizing the reference SCS for each of the multiple carriers in the sidelink communication, wherein each SCS for the multiple carriers are configured the same as the reference SCS. In some embodiments, the method includes applying the reference SCS to subsequent communications. Frequencies for the multiple carriers are configured using the reference SCS. The frequencies are for the configuration information of candidate carrier for transmission (Tx) carrier selection/re-selection or synchronization carrier configuration information. The carrier for transmission (Tx) carrier selection/re-selection configuration information comprises a list of frequencies in sl-FreqInfoList and the synchronization carrier configuration information comprises a list of frequencies in syncFrequencyList. The configuration using the reference SCS ensures transmission boundary alignment. The determining of the reference SCS is based on an implicit criteria comprising at least one of a traffic information including priority level, a remaining packet delay budget (PDB), a carrier corresponding to a logical channel, a transmission congestion level including a Channel Busy Ratio (CBR) or Channel Occupancy Radio (CR), a largest SCS value, a smallest SCS value, a frequency configured most frequently, a frequency configured least frequently, a frequency list associated with traffic, a SCS of a synchronization frequency reference subcarrier spacing, or a SCS of a candidate carrier for transmission (Tx) carrier selection/re-selection. The determining of the reference SCS with the CBR or the CR is based on a frequency with the CBR or the CR measurement is either a lowest or a highest. The determining of the reference SCS with the logical channel is based on a frequency whose corresponding logical channel measures the CBR or the CR values either below or above a threshold. The determining of the reference SCS with the frequency carrying traffic is based on the frequency carrying traffic with a highest or a lowest priority value. The determining of the reference SCS with the PDB is based on the frequency carrying traffic with a smallest or a largest remaining packet delay budget (PDB). The determining of the reference SCS is based on an explicit criteria comprising using a configured/preconfigured SCS and the configured/preconfigured SCS can be for example an information element (IE) of sl-FreqInfoList or inIE syncFrequencyList. Only the carrier(s) whose SCS the same as the configured/preconfigured SCS can be used for candidate carrier for transmission (Tx) carrier selection/re-selection and/or synchronization frequency reference subcarrier spacing. The determining and utilizing is by a user equipment (UE). The UE performs the sidelink communication with the multiple carriers. The determining and utilizing is by a base station in communication with the UE.

In some embodiments, the method includes applying the reference SCS to subsequent communications. In some embodiments, the method includes selecting a frequency for a synchronization reference based on the reference SCS. In some embodiments, the method includes selecting a frequency for Tx carrier(s) based on the reference SCS. A transmission priority is based on the reference SCS. The reference SCS is utilized for a transmission phase for a simultaneous transmission/reception, wherein simultaneous transmission/reception channels or signals with the reference SCS are utilized for a priority comparison. The channels or signals comprises channels or signals from new radio (NR), long term evolution (LTE), physical sidelink feedback channel (PSFCH), sidelink, or uplink.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF DRAWINGS

FIG. 1 shows an example base station.

FIG. 2 shows an example random access (RA) messaging environment.

FIG. 3a shows an example sidelink communication.

FIG. 3b shows another example sidelink communication.

FIG. 3c shows another example sidelink communication.

FIG. 4 shows an example with device to device messaging environment.

FIG. 5 shows an example process with a reference subcarrier spacing (SCS).

FIG. 6 shows example reference SCS determination.

FIG. 7 shows implicit determination criteria for a reference SCS.

FIG. 8 shows explicit determination criteria for a reference SCS.

FIG. 9 shows example reference SCS utilization.

FIG. 10 shows an example reference SCS process.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

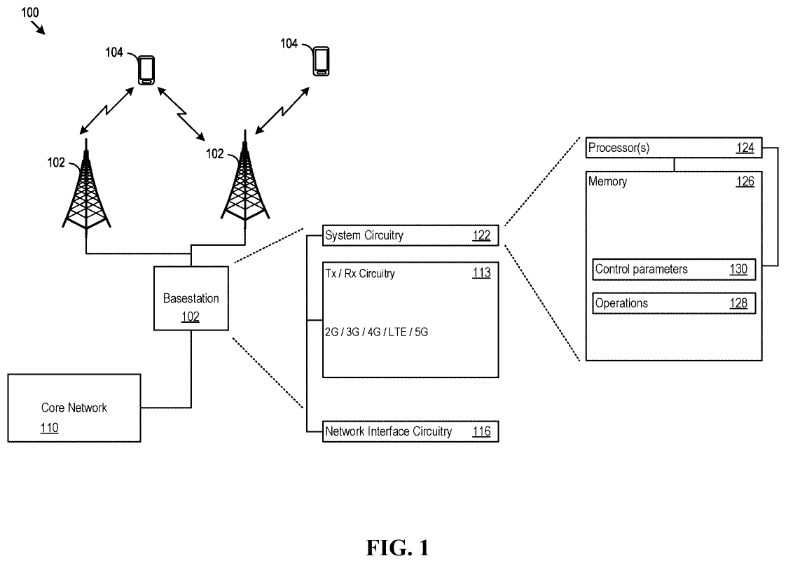

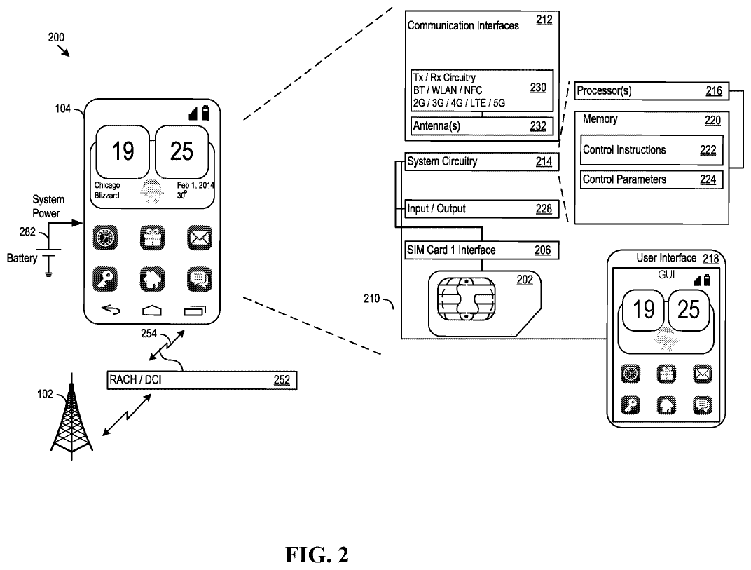

The wireless communications described herein may be through radio access including new radio (“NR”) access. Radio resource control (“RRC”) is a protocol layer between user equipment (“UE”) and the network (e.g. base station or gNB) at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). The UE can transmit data through a Random Access Channel (“RACH”) protocol scheme or a Configured Grant (“CG”) scheme or dynamic grant scheme. The RACH scheme is merely one example of a protocol scheme for communications and other examples, including but not limited to CG, are possible. FIGS. 1-2 show example radio access network (“RAN”) nodes (e.g. base stations) and user equipment and messaging environments. The communications described herein may be specific to sidelink communications, which may also be referred to as device to device (“D2D”) communications.

There may be at least two technical schemes including an internet protocol (“IP”) layer (Layer 3 or “L3”) and an access layer (Layer 2 or “L2”) for the sidelink communications. The layer 3 based relay forwards data according to IP information (e.g. IP address or IP port number) of the UE. The layer 2 based relay routes and forwards data of user plane and control plane in access layer, allowing network operator (i.e. core network and/or the BS) to manage the remote UE more effectively.

Carrier aggregation may include a concatenation of multiple carriers to increase bandwidth. There may be multiple bandwidth options for the carriers. As network technology has improved, a number of carriers that can be supported has increased. Carrier aggregation may include dual connectivity (DC) for different carriers. A UE may simultaneously receive or transmit on one or multiple carriers depending on its capabilities. Carrier aggregation may require an alignment of frame timing and system frame number across cells which can be aggregated.

New radio (NR) may utilize orthogonal frequency division multiplexing (OFDM) which may combine multiple subchannels within a channel. Different numbers of subcarriers can either be added to increase a channel capacity, or reduced to provide lower power (with lower bandwidth) options. The subcarrier spacing (SCS) refers to spacing for the subcarriers on a channel. For example, the NR network may have a SCS between 15 kHz to 240 kHz, with a maximum number of subcarriers in simultaneous use on one channel. Channels may be limited in width (e.g. 400 MH). Frequency can be varied, such that subcarrier configuration or SCS can be varied.

For carrier aggregation, coexistence and other concerning use cases, a UE may perform sidelink transmission and reception using different carriers of interest simultaneously. For example, the carrier selection may be done assuming always a single carrier among the maximum supported capability (e.g. up to 8 carriers in one embodiment). When there are multiple carriers with different SCS that are selected and used simultaneously, then keeping the existing physical layer structure unchanged may lead to some issues on Automatic Gain Control (AGC) and transmit (Tx) and receive (Rx) transient process. Specifically, because the one symbol overhead allocated for the larger SCS cannot cover the corresponding settling time for the smaller SCS which would expand longer in time. As described below, ensuring the SCS of different carriers are configured the same, or in an alternative embodiment, determining a reference SCS may address the issue. The reference SCS may be determined from a set including different SCS values and may be utilized for a subsequent transmission/procedure.

In some embodiments, the reference SCS determination and utilization may be for sidelink communications. Sidelink communications may relieve the burden of the cellular network, power consumption of user equipment (“UE”) can be reduced, data rates can be increased, and robustness of network infrastructures can be improved, all of which can fulfill the demands of high data rate services and the proximity services. The relay communications or D2D technology may also be referred to as a proximity service (“ProSe”) or sidelink communications. An interface between equipment may be known as or referred to as a PC5 interface where the UE directly communicates with another UE over a direct channel without the base station. In some embodiments, the sidelink-based relay communication may be applied to indoor relay communication, smart farming, smart factory and public safety services. The channel or sidelink channel includes at least one of a physical sidelink shared channel (PSSCH), a Physical Sidelink Feedback Channel (PSFCH), or a Physical Sidelink Broadcast Channel (PSBCH). A unit of the frequency resource of SL-PRS comprises at least one of a Physical Resource block (PRB), a sub-channel, or a Resource element (RE).

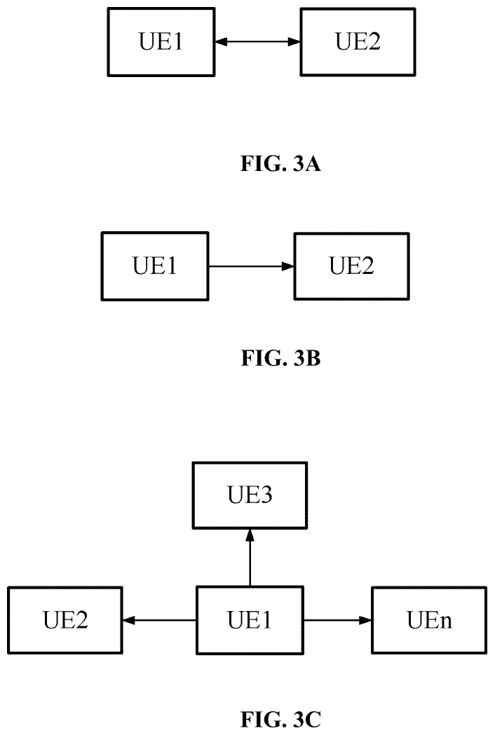

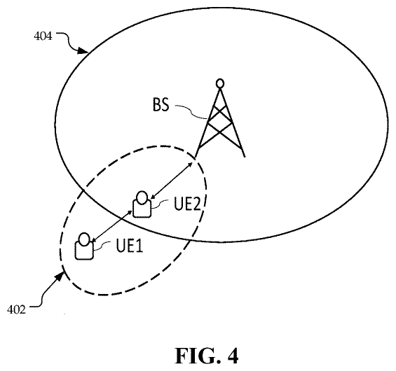

FIGS. 3a-4 show exemplary embodiments for sidelink communications. FIGS. 1-2 show example base stations and user equipment and messaging environments which may be applicable to sidelink communications or the SCS determination/utilization as described below.

FIG. 1 shows an example base station 102. The base station may also be referred to as a wireless network node. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

FIG. 3a shows an example sidelink communication. Sidelink communication may also be referred to as sidelink messaging, sidelink relay, relay communications, or device to device (“D2D”) communication/messaging. FIG. 3a shows two-way sidelink communication between two UEs. UE1 transmits to UE2, and UE2 transmits to UE1. This example shows the UE may report/transmit/request information to another UE (i.e. UE2) or the information is requested/responded by another UE (i.e. UE2). The sidelink communications may further include a send, a receive, a broadcast, a unicast, a request, a response, a forward, an exchange or a groupcast.

FIG. 3b shows another example sidelink communication. FIG. 3b shows one-way sidelink communication between two UEs. In this example, the UE1 transmits/reports information to UE2. UE2 receives the transmitted information from UE1. In this example, the information may also be requested by UE2.

FIG. 3c shows another example sidelink communication. FIG. 3c shows a UE (UE1) that broadcasts to multiple UEs. In this example, UE1 broadcasts/transmits information to n number of UEs (where n is an integer). The UEs report/transmit information or capability may include a broadcast, groupcast (when HARQ-ACK information includes ACK or NACK), unicast, or a groupcast (when HARQ-ACK information includes only).

FIG. 4 shows an example with device to device messaging environment. The sidelink communications between UEs may also include the network, such as the base station (also referred to as NG-RAN). The network may further include a core network, a Transmission/Reception Point (TRP), or a Location Management Function (LMF). The UE may communicate through any of the mechanisms described above with respect to FIGS. 3a-3c.

Specifically, FIG. 4 illustrates a base station (“BS”) with a communication range 404. A second user equipment (“UE2”) is within the range of the BS's communication range 404, while a first user equipment (“UE1”) is out of the range of the communication range 404. The UE1 and UE2 establish relay communications 402 through which UE2 is the relay UE and UE1 is the remote UE. For relay communications, a remote UE (UE1) communicates with the network through a relay UE (UE2). The relay UE (UE2) relays communications between the base station (BS) and the remote UE (UE1). In some embodiments, relay communications may be designed for UE1 in an area with weak or no coverage. UE1 is allowed to communicate with the base station BS through a relay UE (UE2). As a result, the coverage of the network 404 is extended out to include the relay communication coverage area 402 (including UE1) and the capacity of the network is enlarged.

In some embodiments, such as during emergency situations (e.g. earthquake), the cellular network may operate abnormally or a sidelink communication range of the network may need to be extended. Thus, the relay communications may be designed for allowing multiple UEs to communicate with each other via the relay UE. Although not shown, there may be multiple UEs in a relay communication chain, or a relay UE may have multiple remote UEs. The interface in FIG. 4 between the UE and BS during relay communications is referred to as the Uu interface.

In some embodiments, the UE2 can further communicate with the network (e.g. through a base station). In some embodiments, the sidelink communications may be between user equipment (UE), a network node, a base station, a local sever, a Transmission/Reception Point (TRP), or a Location Management Function (LMF). Although not shown in FIGS. 3a-4, UE2 can receive information from another UE (UE1) that is then communicated to the network/base station.

As discussed, for carrier aggregation a UE may perform sidelink transmission and reception using different carriers of interest simultaneously. When there are multiple carriers with different SCS that are selected and used simultaneously, then keeping the existing physical layer structure unchanged may lead to some issues on Automatic Gain Control (AGC) and transmit (Tx) and receive (Rx) transient process. Accordingly, ensuring the SCS of different carriers are configured the same may address the issue.

In one embodiment, the SCS for each of the frequency in either a Carrier Configuration Information or in a Synchronization Carrier Configuration Information may be configured the same. In some embodiments, the Carrier Configuration Information may be sl-FreqInfoList and the Synchronization Carrier Configuration Information may be syncFrequencyList.

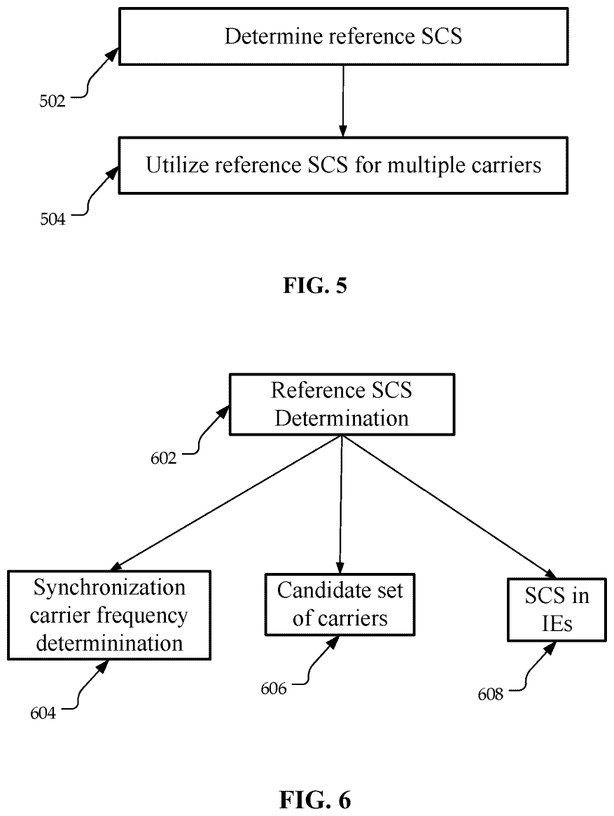

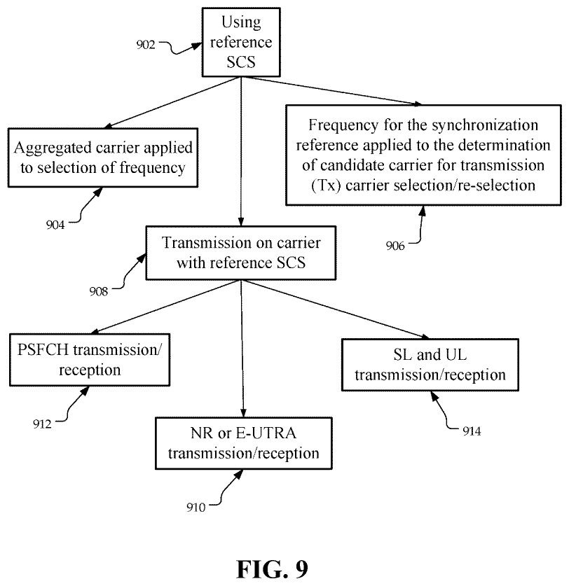

In another embodiment, a reference SCS is determined and utilized as in FIG. 5. FIG. 5 shows an example process with a reference subcarrier spacing (SCS). In block 502, the reference SCS is determined. The reference SCS determination is further described with respect to FIGS. 6-8. In block 504, the reference SCS may be utilized for multiple carriers. The utilization may be for a subsequent transmission/procedure and is further described with respect to FIG. 9.

FIG. 6 shows example reference SCS determination. In block 502 of FIG. 5, the reference SCS is determined. This reference SCS determination is in block 602. As discussed, the reference SCS can be used for multiple carriers (e.g. block 504 in FIG. 5). The determination of the reference SCS in block 602 may be necessary when the SCS for the frequencies of Carrier Configuration Information (e.g. sl-FreqInfoList) or the Synchronization Carrier Configuration Information (e.g. syncFrequencyList) are different. The reference SCS could be determined differently than the examples shown in FIG. 6, such as through any of the features/components of the other frequencies.

When the SCS for frequencies of Carrier Configuration Information (e.g. sl-FreqInfoList) or the Synchronization Carrier Configuration Information (e.g. syncFrequencyList) are configured differently the reference SCS may be generated in the process of synchronization carrier frequency determination and/or as a SCS of a selected carrier frequency as in block 604. The may be further applied to determine the carriers for aggregation. In one example, only the carrier(s) configured with the reference SCS may be applied for aggregation.

The reference SCS that is determined from either the configured/preconfigured SCS in Carrier Configuration Information (e.g. sl-FreqInfoList) or the Synchronization Carrier Configuration Information (e.g. syncFrequencyList) or when one of the aggregated carriers can be applied to the selection of the frequency for the synchronization reference. The following example pseudo-code is one example for this determination:
1> If syncFreqList is included in RRCConnectionReconfiguration or in SystemInformationBlockType26, and includes at least one of the concerned frequency(ies):
2> if no synchronization carrier frequency is selected:
3> If typeTxSync is configured for the concerned frequency(ies) and set to enb; or
3> if typeTxSync for the concerned frequency(ies) is not configured or is set to gnss, and GNSS is reliable:
4> select one frequency of subcarrrier spacing equal to reference SCS from the concerned frequency(ies) which are included in sync FreqList as the synchronization carrier frequency.
3> else (i.e., there is no GNSS which is reliable):
4> select the synchronization reference source(s) on the concerned frequency(ies) which are included in syncFreqList:
4> if SyncRef UE(s) with SLSSID=0 is detected on at least one frequency from the concerned frequency(ies):
5> select one frequency of subcarrrier spacing equal to reference SCS from the concerned frequency(ies) with the SyncRef UE(s) with SLSSID=0 detected as the synchronization carrier frequency;
4> else (i.e., no SLSSID=0 detected and UE selects a cell as the synchronization reference source):
5> select one frequency of subcarrrier spacing equal to reference SCS from the concerned frequencies which are included in syncFreqList as the synchronization carrier frequency;
2> else (i.e. the synchronization carrier frequency is selected):
3> If the UE selects GNSS as the synchronization reference source, and GNSS is unreliable; or
3> If the UE selects a cell as the synchronization reference source, and the cell cannot fulfil the S criterion; or
3> If the UE selects a SyncRef UE and the S-RSRP of the current SyncRef UE is less than the minimum requirement; or
3> If the synchronization carrier frequency is not selected for vehicle-to-everything (V2X) sidelink communication:
4> consider no synchronization carrier frequency is selected.

In another example, the reference SCS determination 602 comprises a candidate set of carriers in block 606 from which a selection/determination is made. In the process of determining the set of carriers for aggregation and/or as a SCS of a carrier in the aggregation and further applied to determine the synchronization reference carrier (e.g. only the carrier(s) configured/preconfigured with the reference carrier spacing shall be the synchronization reference carrier). The reference SCS determined from either the configured/preconfigured SCS in Carrier Configuration Information (e.g. sl-FreqInfoList) or the Synchronization Carrier Configuration Information (e.g. syncFrequencyList) or as that in frequency for synchronization reference can be applied to the selection of the frequency for the synchronization reference.

The transmission (Tx) carrier selection procedure may include the MAC entity which may consider a Channel Busy Ratio (CBR) of a carrier to be one measured by lower layers if CBR measurement results are available, or the corresponding defaultTxConfigIndex configured by upper layers for the carrier if CBR measurement results are not available. If the TX carrier selection or re-selection is triggered for a sidelink communication, then the MAC entity may:
if there is no configured sidelink grant on any carrier allowed for the sidelink logical channel where data is available as indicated by upper layers,
for each carrier configured by upper layers associated with the concerned sidelink logical channel,
if the CBR of the carrier is below a threshold (e.g. threshCBR-FreqReselection) associated with a priority of the sidelink logical channel and the SCS of the carrier equals to the reference SCS;
then consider the carrier as a candidate carrier for TX carrier selection or re-selection for the concerned sidelink logical channel.

In an alternative, for each sidelink logical channel, where data is available and is allowed on the carrier for which Tx carrier selection or re-selection is triggered, then if the CBR of the carrier is below a threshold (e.g. threshCBR-FreqKeeping) associated with a priority of the sidelink logical channel, then the SCS of the carrier equals to the reference SCS and the carrier and the associated pool of resources are selected. Alternatively, for each carrier configured by upper layers on which the sidelink logical channel is allowed, if the CBR of the carrier is below the threshold (e.g. threshCBR-FreqReselection) associated with the priority of the sidelink logical channel the SCS of the carrier equals the reference SCS and the carrier is considered as a candidate carrier for TX carrier selection or re-selection.

In block 608, the reference SCS may be determined from the differently configured/preconfigured SCS in information elements (IEs) of Carrier Configuration Information (e.g. sl-FreqInfoList) or the Synchronization Carrier Configuration Information (e.g. syncFrequencyList) to be further applied to determine the synchronization reference carrier and the aggregated carrier. For example, only the carrier(s) configured with the reference SCS may be used for a synchronization reference carrier or as a component carrier for carrier aggregation.

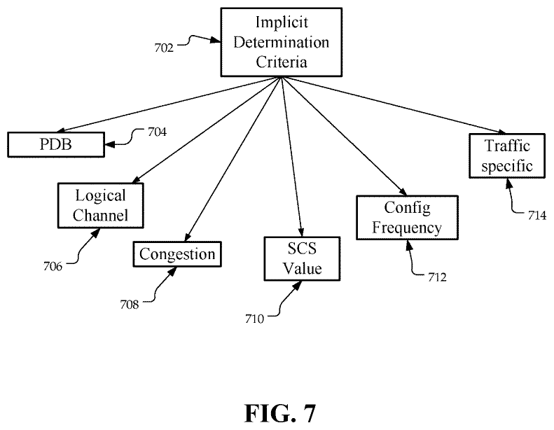

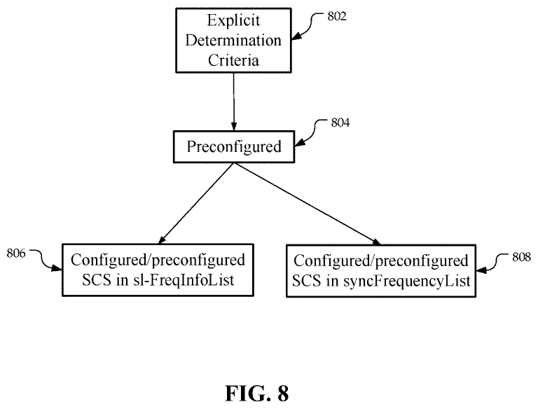

FIGS. 7-8 illustrate criteria that can be used for making the determination of reference SCS. They may be used in any of the examples shown in FIG. 6 or may be independent determinations for the reference SCS.

FIG. 7 shows implicit determination criteria 702 for a reference SCS. The SCS for carriers may be determined based on:
the traffic information including priority level and/or remaining Packet Delay Budget (PDB) as in block 704;
the carrier corresponding to the logical channel or a priority related to the logical channel as in block 706;
the transmission congestion level including Channel Busy Ratio (CBR) or Cognitive Radio (CR) to use carriers that are less congested (e.g. the frequency whose resource pool measures the lowest CBR or CR level) as in block 708;
using either the largest SCS value or the smallest SCS value as in block 710;
using the SCS whose corresponding frequency is configured either the most times (the mode of the frequencies) or the least number of times as in block 712;
a traffic specific frequency list as in block 714.

FIG. 8 shows explicit determination criteria 802 for a reference SCS. They may be used in any of the examples shown in FIG. 6 or may be independent determinations for the reference SCS, which may be configured/preconfigured 804. In block 806, the configured/preconfigured SCS may be in Carrier Configuration Information (e.g. sl-FreqInfoList). In other words, the SCS for carriers may be determined based on using a configured/preconfigured SCS in IE Carrier Configuration Information (e.g. sl-FreqInfoList). In block 808, the configured/preconfigured SCS may be in Synchronization Carrier Configuration Information (e.g. syncFrequencyList). In other words, the SCS for carriers may be determined based on using a configured/preconfigured SCS in IE Synchronization Carrier Configuration Information (e.g. syncFrequencyList). There may be configuration/preconfiguration to enable either one of or both of the implicit determination criteria 702 and the explicit determination criteria 802.

FIG. 9 shows example reference SCS utilization 902. The reference SCS may be applied to selection of frequency used for an aggregated carrier in block 904. In other words, the reference SCS determined as in one of the aggregated carriers can be applied to the selection of the frequency for the synchronization reference. In block 906, frequency for synchronization reference may be applied to the determination of a candidate carrier for transmission (Tx) carrier selection/re-selection. In other words, the reference SCS determined as in frequency for the synchronization reference can be applied to the determination of a candidate carrier for transmission (Tx) carrier selection/re-selection

If there is a transmission, it may occur with the reference SCS rather than priority based only in some embodiments. The reference SCS is determined and can then be applied to a transmission phase as in block 908. In block 910, the transmission/reception in this example is New Radio (NR) or Evolved Universal Terrestrial Radio Access (E-UTRA). In an example of simultaneous NR and E-UTRA transmission/reception, there may be a conflict when:
there is a UE transmission a first channel/signal using E-UTRA radio access and second channels/signals using NR radio access;
a transmission of the first channel/signal would overlap in time with a transmission of the second channels/signals;
the priorities of the channels/signals are known to both E-UTRA radio access and NR radio access at the UE T milliseconds prior to the start of the earliest of the two transmissions. In some embodiments, T<<4 and is based on UE implementation.

The UE transmits only the channels/signals with the reference SCS of the radio access technology with the highest priority as determined by the SCI formats scheduling the transmissions. In an alternative embodiment, with a secondary synchronization signal (S-SS), a Physical Sidelink Broadcast Channel (PSBCH) block, or a sidelink synchronization signal using E-UTRA radio access, as indicated by higher layers. In an example with physical sidelink feedback channel (PSFCH), it may be equal to the priority of the corresponding physical sidelink shared channel (PSSCH).

In another example embodiment of simultaneous NR and E-UTRA transmission/reception, there may be a conflict when:
the UE would respectively transmit or receive a first channel/signal using E-UTRA radio access and receive a second channel/signal or transmit second channels/signals using NR radio access;
a transmission or reception of the first channel/signal would respectively overlap in time with a reception of the second channel/signal or transmission of the second channels/signals;
the priorities of the channels/signals are known to both E-UTRA radio access and NR radio access at the UE T msec prior to the start of the earliest transmission or reception.

In some embodiments, T<<4 and is based on UE implementation

The UE transmits or receives the channels/signals with the reference SCS of the radio access technology with the highest priority as determined by the SCI formats scheduling the transmissions. In an alternative embodiment, in case of a S-SS/PSBCH block or a sidelink synchronization signal using E-UTRA radio access, as indicated by higher layers. In an example with PSFCH, it may be equal to the priority of the corresponding PSSCH.

In block 912, the transmission with the reference SCS may be through simultaneous physical sidelink feedback channel (PSFCH) transmission/reception. The reference SCS determined can be applied to transmission phase in simultaneous PSFCH transmission/reception as in block 912. For simultaneous PSFCH transmission/reception, the UE transmits or receives only a set of PSFCHs corresponding to the smallest priority field value, as determined by a first set of SCI format 1-A and a second set of SCI format 1-A. They may be respectively associated with the N_(sch, Tx,PSFCH) PSFCHs and the N_(sch,Rx,PSFCH) PSFCHs in a resource pool with reference SCS. If a UE would transmit N_(sch,Tx,PSFCH) PSFCHs in a PSFCH transmission occasion, the UE transmits N_(Tx,PSFCH) PSFCHs corresponding to the smallest N_(Tx,PSFCH) priority field values indicated in all SCI formats 1-A associated with the PSFCH transmission occasion in a resource pool configured with reference SCS. The transmitted PSFCH can convey HARQ-ACK information as well as conflict information.

In block 914, the transmission with the reference SCS may be through simultaneous sidelink (SL) and/or uplink (UL) transmission/reception. The reference SCS determined can be applied to a transmission phase with simultaneous SL and UL transmission/receptions. In an example with simultaneous SL and UL transmissions/receptions, 1) if a UE would simultaneously transmit on the UL and on the SL in a carrier or in two respective carriers; and 2) the UE is not capable of simultaneous transmissions on the UL and on the SL in the carrier or in the two respective carriers, then the UE transmits only on the link, UL or SL in a resource pool configured with a reference SCS, with the higher priority. In another example, 1) if a UE would simultaneously transmit on the UL and receive on the SL in a carrier; or 2) if a UE would simultaneously transmit on the UL and receive on the SL in two respective carriers and the UE is not capable of simultaneous transmission on the UL and reception on the SL in the two respective carriers, then the UE transmits on UL or receives on SL in a resource pool configured with reference SCS, with the higher priority. In another example, 1) if a UE is capable of simultaneous transmissions on the UL and on the SL in two respective carriers; and 2) if a UE would transmit on the UL and on the SL in a resource pool configured with reference SCS in the two respective carriers; 3) the transmission on the UL would overlap with the transmission on the SL in a resource pool configured with reference SCS over a time period; and 4) the total UE transmission power over the time period would exceed a threshold (e.g. P_“CMAX”), then the UE can:
reduce the power for the UL transmission prior to the start of the UL transmission, if the SL transmission in a resource pool configured with reference SCS has higher priority than the UL transmission, so that the total UE transmission power would not exceed P_“CMAX”; or
reduce the power for the SL transmission in a resource pool configured with reference SCS prior to the start of the SL transmission, if the UL transmission has higher priority than the SL transmission, so that the total UE transmission power would not exceed P_“CMAX”.

In some embodiments, there may be prioritizations for sidelink (SL) and uplink (UL) transmissions/receptions. In one embodiment, when one or more SL transmissions in a resource pool configured with reference SCS from a UE overlap in time with multiple non-overlapping UL transmissions from the UE, the UE performs the SL transmissions if at least one SL transmission is prioritized over all UL transmissions subject to the UE processing timeline with respect to the first SL transmission and the first UL transmission. In one embodiment, when one or more UL transmissions from a UE overlap in time with multiple non-overlapping SL transmissions in a resource pool configured with reference SCS, the UE performs the UL transmissions if at least one UL transmission is prioritized over all SL transmissions subject to the UE processing timeline with respect to the first SL transmission and the first UL transmission. In one embodiment, when one SL transmission in a resource pool configured with reference SCS overlaps in time with one or more overlapping UL transmissions, the UE performs the SL transmission if the SL transmission is prioritized over all UL transmissions subject to both the UE multiplexing and processing timelines with respect to the first SL transmission and the first UL transmission, where the UE processing timeline with respect to the first SL transmission and the first UL transmission is same as when one or more SL transmissions overlap in time with multiple non-overlapping UL transmissions. In one embodiment, when one SL transmission overlaps in time with one or more overlapping UL transmissions, the UE performs the UL transmission if at least one UL transmission is prioritized over the SL transmission subject to both the UE multiplexing and processing timelines with respect to the first SL transmission and the first UL transmission, where the UE processing timeline with respect to the first SL transmission and the first UL transmission is same as when one or more SL transmissions overlap in time with multiple non-overlapping UL transmissions.

If the synchronization carrier is selected, all the currently used carriers of the UE may use the synchronization reference selected on the synchronization carrier. In other words, the carriers may use the synchronization reference on the synchronization carrier to send and receive. If there is no synchronization carrier, the UE selects a synchronization reference on each carrier, but the UE may only aggregate the same carrier for transmission.

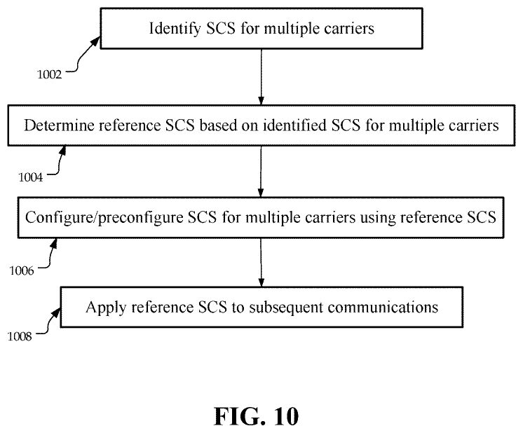

FIG. 10 shows an example reference SCS process. The example process may rely on the embodiments described above and any can apply to this process. In block 1002, SCS is identified for multiple carriers. In block 1004, a reference SCS may be determined based at least in part on the identified SCS for multiple carriers. This determination may utilize any of the embodiments described above. In block 1006, the SCS is configured/preconfigured for the multiple carriers using the determined reference SCS. This configuration/preconfiguration prevents conflicts for the SCS for the multiple carriers. In block 1008, the reference SCS may be applied to subsequent communications.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication, comprising:
determining a reference subcarrier spacing (SCS) for multiple carriers in a sidelink communication; and
utilizing the reference SCS for each of the multiple carriers in the sidelink communication.

2. The method of claim 1, wherein each SCS for the multiple carriers are configured the same as the reference SCS.

3. The method of claim 1, wherein frequencies for the multiple carriers are configured using the reference SCS.

4. The method of claim 3, wherein the frequencies are for configuration information of candidate carrier for transmission (Tx) carrier selection/re-selection or synchronization carrier configuration information.

5. The method of claim 4, wherein a beam identifier comprises a Synchronization Signal/Physical Broadcast Channel (PBCH) Block (SSB) index associated with a beam.

6. (canceled)

7. The method of claim 1, wherein the determining of the reference SCS is based on an implicit criteria comprising at least one of a traffic information including priority level, a remaining packet delay budget (PDB), a carrier corresponding to a logical channel, a transmission congestion level including a Channel Busy Ratio (CBR) or Channel Occupancy Radio (CR), a largest SCS value, a smallest SCS value, a frequency configured most frequently, a frequency configured least frequently, a frequency list associated with traffic, a SCS of a synchronization frequency reference subcarrier spacing, or a SCS of a candidate carrier for Tx carrier selection/re-selection.

8. The method of claim 7, wherein the determining of the reference SCS with the CBR or the CR is based on a frequency with the CBR or the CR measurement either a lowest or a highest.

9. The method of claim 7, wherein the determining of the reference SCS with the logical channel is based on a frequency whose corresponding logical channel measures the CBR or the CR values either below or above a threshold.

10. The method of claim 7, wherein the determining of the reference SCS with the frequency carrying traffic is based on the frequency carrying traffic with a highest or a lowest priority value.

11. The method of claim 7, wherein the determining of the reference SCS with the PDB is based on the frequency carrying traffic with a smallest or a largest remaining PDB.

12. The method of claim 1, wherein the determining of the reference SCS is based on an explicit criteria comprising using a configured/preconfigured SCS, and wherein the configured/preconfigured SCS is an information element (IE) of sl-FreqInfoList or inIE syncFrequencyList.

13. (canceled)

14. The method of claim 1, wherein the determining and utilizing is by a user equipment (UE), and the UE performs the sidelink communication with the multiple carriers; or,
wherein the determining and utilizing is by a base station in communication with a UE.

15-17. (canceled)

18. The method of claim 1, further comprising:
selecting a frequency for a synchronization reference based on the reference SCS.

19. The method of claim 1, further comprising:
selecting a frequency for a Tx carrier based on the reference SCS.

20. The method of claim 1, wherein a transmission priority is based on the reference SCS.

21. The method of claim 1, wherein the reference SCS is utilized for a transmission phase for a simultaneous transmission/reception, wherein simultaneous transmission/reception channels or signals with the reference SCS are utilized for a priority comparison.

22. (canceled)

23. A method for wireless communication, comprising:
identifying a subcarrier spacing (SCS) for multiple carriers in a sidelink communication;
determining a reference SCS for the multiple carriers; and
utilizing the reference SCS for each of the multiple carriers in the sidelink communication,
wherein each SCS for the multiple carriers are configured the same as the reference SCS.

24. The method of claim 23, further comprising:
applying the reference SCS to subsequent communications.

25. A wireless communications apparatus comprising a processor and a memory, wherein the processor is configured to read code from the memory and implement:
determining a reference subcarrier spacing (SCS) for multiple carriers in a sidelink communication; and
utilizing the reference SCS for each of the multiple carriers in the sidelink communication.

26. (canceled)

27. A non-transitory computer-readable storage medium comprising instructions, wherein the instructions, when executed by a processor, cause the processor to implement the method recited in claim 1.
